(19) United States
(12) Patent Application Publication
(10) Pub. No.: US 2024/0020703 A1
(43) Pub. Date: Jan. 18, 2024

(54) AVOIDING IRREVERSIBLE LEDGER TRANSACTIONS HAVING AN INCORRECT ADDRESS

(71) Applicant: LENOVO (SINGAPORE) PTE. LTD, Singapore (SG)

(72) Inventors: Russell Speight Vanblon, Raleigh, NC (US); Scott Wentao Li, Cary, NC (US); Robert James Norton, JR., Raleigh, NC (US); Robert J. Kapinos, Durham, NC (US)

(21) Appl. No.: 17/813,223

(22) Filed: Jul. 18, 2022

(51) Int. Cl. G06Q 20/40; G06Q 20/38; G06Q 20/06

(52) U.S. Cl. CPC G06Q 20/405; G06Q 20/3825; G06Q 20/065

(57) ABSTRACT

A system avoids irreversible transactions on a digital ledger system. The system receives a request to add a block at a first address, searches for a second address that is similar to the first address, and transmits a message to a user indicating that there may be an error when the second address closely matches the first address. The system also determines that the first address is registered and has been used, and when the first address is registered but has not been used, the system denies the request from the user to add the block to the ledger system or requests a confirmation from the user that the user wants to add the block to the ledger at the first address. The system also refrains from adding the block to the ledger for a predetermined threshold time period, and after an expiration of the predetermined threshold time period, adds the block to the ledger.

### TECHNICAL FIELD

Embodiments described herein generally relate to avoiding irreversible digital ledger transactions that have an incorrect address.

### BACKGROUND

Currently, in digital ledger systems, such as a blockchain system, only invalid destination addresses are identified and prevented from being added to the ledger. An invalid address, for example, is an address that does not have the proper number of characters. The address may contain too few or too many numbers and/or characters. However, the identification and prevention of invalid destination addresses in a ledger does not prevent an address that may be valid, but is incorrect, from being erroneously added to the ledger. For example, the address may be valid because it is the proper length, but a single character in the address may be incorrect, and such an incorrect address could be added to the ledger. Such a valid but incorrect address still results in irreversible harm, because, for example, the incorrect address has no known recipient. This situation is a problem in any ledger, not just in a blockchain or a cryptocurrency-based blockchain.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram of features and operations of an embodiment that avoids irreversible digital ledger transactions that have an incorrect address.

FIG. 2 is a block diagram of features and operations of another embodiment that avoids irreversible digital ledger transactions that have an incorrect address.

FIG. 3 is a block diagram of features and operations of another embodiment that avoids irreversible digital ledger transactions that have an incorrect address.

FIG. 4 is a block diagram of a computer architecture upon which one or more embodiments of the present disclosure can execute.

### DETAILED DESCRIPTION

One or more embodiments of the present disclosure address the situation wherein a user tries to commit a block in a blockchain associated with a non-registered address, and these embodiments can prevent irreversible damage to the blockchain. As is known to those of skill in the art, a blockchain is a digital, decentralized ledger database that records and stores all transactions between users on a given network. Transaction records (or blocks) are timestamped and cryptographically secured, locking them in a linear, chronological order. This provides a transparent, immutable collection of every record, safeguarded against tampering. Two well-known blockchain platforms are Hyperledger Fabric and Ethereum.

A first embodiment checks similar destination addresses. Because of the structure and nature of blockchains, it is extremely rare that a destination address entered by a user would closely match another address in the blockchain. Consequently, if and when this does occur, the user is notified of this situation and the possible destination address error. This embodiment can leverage regular expressions algorithms to quickly identify matching addresses.

A second embodiment leverages previously used addresses. Addresses in a blockchain are registered, although they need not disclose to whom they are registered, but they can. Consequently, even unused addresses could be registered. If an address is not registered, the embodiment can either deny sending the transaction (e.g., currency) to the address, or it can require user confirmation. Further, the embodiment can simply check for past address usage (e.g., a transaction or a signed message in the chain indicating an address was used). It is noted that a sender can also register an address to themselves to allow a transaction to go through to their own wallet, or to override warnings. The registry can be private within an organization (e.g., Coinbase), or it can be public across all consumers of the blockchain. This embodiment can also use a dual transaction model for each transaction. That is, first a “trial” transaction can be transmitted to ensure that the destination address is appropriately reached before committing to that address. Second, a “commit” transaction can be transmitted to commit the block to the blockchain.

A third embodiment relates to a time-based reversal. This embodiment leverages an optional sender-specified or blockchain-imposed reversal time period. The sender can reverse the transaction within the time period. Recipients are made aware of the time-period (if specified) to factor into transactions and handle appropriately. This can be implemented on the blockchain itself, in a hardware wallet, software wallet, or on an exchange. For example, Coinbase could do this on any existing blockchain coin or token by analyzing unused addresses.

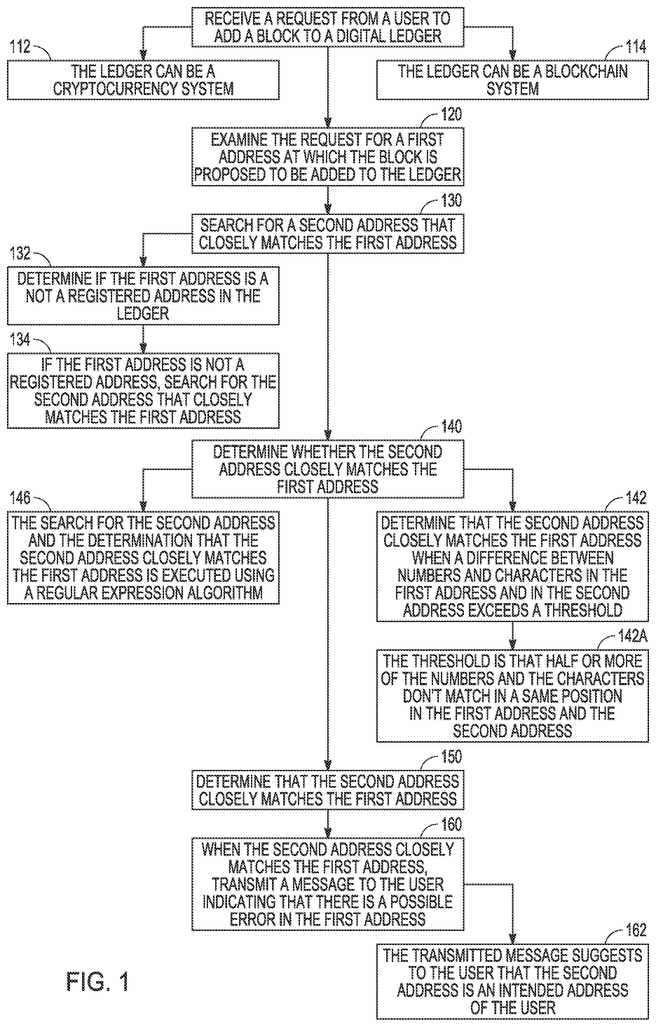

FIGS. 1, 2 and 3 are block diagrams illustrating operations and features of systems to avoid irreversible ledger transactions that have an incorrect address. FIGS. 1, 2 and 3 include a number of feature and process blocks 110-162, 210-246C, and 310-330. Though arranged substantially serially in the example of FIGS. 1, 2 and 3, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring first to FIG. 1, at 110, a request is received from a user to add a block to a digital ledger. Such digital ledgers can also be referred to as a distributed file system, and they can be public or private in nature. As indicated at 112, the ledger can be a cryptocurrency system, and as indicated at 114, the ledger can be a blockchain system. At 120, the request is examined and a first address at which the block is proposed to be added to the ledger is determined.

At 130, a second address is searched for that closely matches the first address. In an embodiment, at 132, a determination is first made if the first address is a not a registered address in the ledger. Then, at 134, if the first address is not a registered address, only then is there a search for the second address that closely matches the first address. The operations of blocks 132 and 134 conserve system resources by only searching for closely matching addresses when a user has entered a non-registered address and therefore it is likely that a mistake has been made.

As indicated at 140, a determination is made as to whether the second address closely matches the first address. As noted above, it is highly unlikely that two addresses in a digital or on online ledger will closely match or be very similar. Consequently, if a user enters an address that closely matches another address in the ledger, it is likely that the user made a mistake and meant to enter the closely matching address, not the address the user actually entered. As indicated at 142, a determination is made that the second address closely matches the first address when a difference between numbers and characters in the first address and in the second address exceeds a threshold. As indicated at 142A, the threshold, for example, could be that half or more of the numbers and the characters don't match in a same position in the first address and the second address. As indicated at 146, in an embodiment, the search for the second address and the determination that the second address closely matches the first address is executed using a regular expression algorithm.

At 150, a determination is made that the second address closely matches the first address, and as indicated at 160, when the second address closely matches the first address, a message is transmitted to the user indicating that there is a possible error in the first address. At 162, the transmitted message suggests to the user that the second address is an intended address of the user. That is, that the user made a mistake in entering the first address.

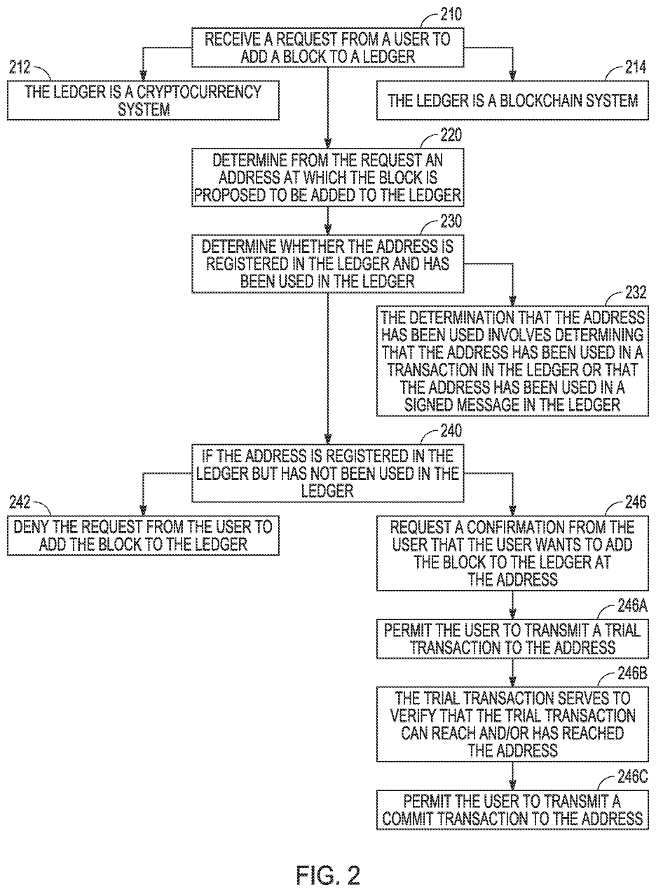

Referring now to FIG. 2, at 210, a request is received from a user to add a block to a ledger. Like with the embodiment of FIG. 1, the ledger can be a cryptocurrency system (212), or the ledger can be a blockchain system (214).

At 220, it is determined from the request an address at which the block is proposed to be added to the ledger by the user.

Then, at 230, a determination is made as to whether the address is registered in the ledger and has been used in the ledger. As indicated at 232, the determination that the address has been used involves determining that the address has been used in a transaction in the ledger or that the address has been used in a signed message in the ledger.

At 240, if the address is registered in the ledger but has not been used in the ledger, either the request from the user to add the block to the ledger is denied at 242, or at 246, a confirmation is requested from the user that the user wants to add the block to the ledger at the address. In an embodiment, the confirmation that is requested from the user can include several operations. At 246A, the user is permitted to transmit a trial transaction to the address. As indicated at 246B, the trial transaction serves to verify that the trial transaction can reach and/or has reached the address. Then, at 246C, the user is permitted to transmit a commit transaction to the address. The commit transaction is the entire transaction desired by the user, and this entire transaction is added to the ledger.

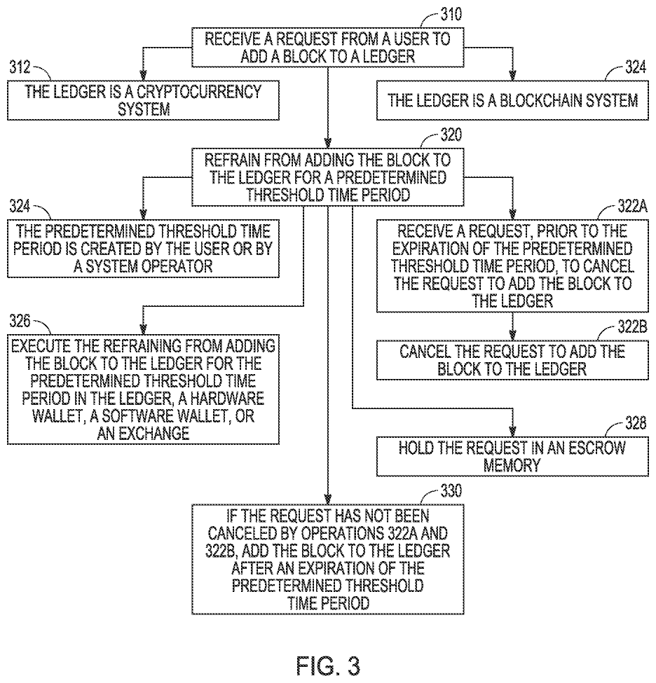

Referring now to FIG. 3, at 310, a request is received in a system from a user to add a block to a digital ledger. Like in the embodiments of FIGS. 1 and 2, the ledger can be a cryptocurrency system (312), or the ledger comprises a blockchain system (314).

At 320, the system refrains from adding the block to the ledger for a predetermined threshold time period. In an embodiment, at 322A, a request is received, prior to the expiration of the predetermined threshold time period, to cancel the request to add the block to the ledger. Then, at 322B, the request to add the block to the ledger is canceled. As indicated at 324, the predetermined threshold time period can be created by the user, or the predetermined threshold time period can be created by a system operator.

As indicated at 326, the refraining from adding the block to the ledger for the predetermined threshold time period is executed in the ledger, a hardware wallet, a software wallet, or an exchange. And as indicated at 328, the refraining includes holding the request in an escrow memory.

Then, if the request has not been canceled by operations 322A and 322B, at 330, after an expiration of the predetermined threshold time period, the block is added to the ledger.

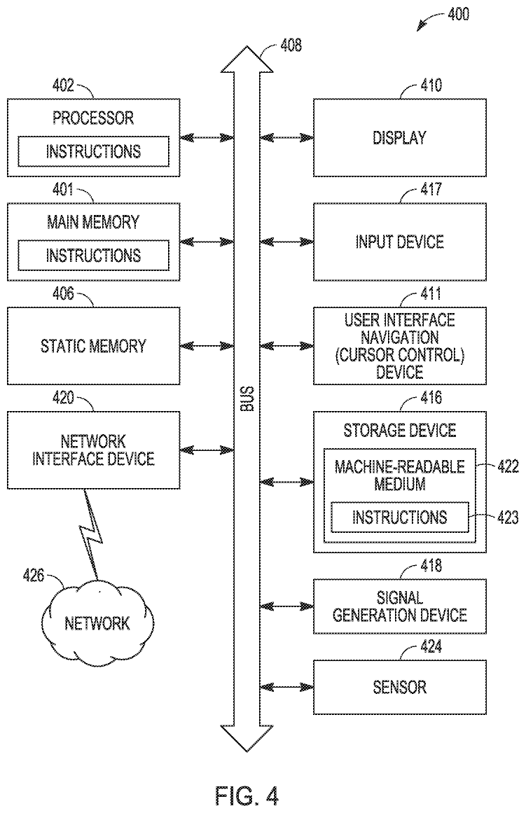

FIG. 4 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 401 and a static memory 406, which communicate with each other via a bus 408. The computer system 400 may further include a display unit 410, an alphanumeric input device 417 (e.g., a keyboard), and a user interface (UI) navigation device 411 (e.g., a mouse). In one embodiment, the display, input device and cursor control device are a touch screen display. The computer system 400 may additionally include a storage device 416 (e.g., drive unit), a signal generation device 418 (e.g., a speaker), a network interface device 420, and one or more sensors 424, such as a global positioning system sensor, compass, accelerometer, or other sensor.

The storage device 416 includes a machine-readable medium 422 on which is stored one or more sets of instructions and data structures (e.g., software 423) embodying or utilized by any one or more of the methodologies or functions described herein. The software 423 may also reside, completely or at least partially, within the main memory 401 and/or within the processor 402 during execution thereof by the computer system 400, the main memory 401 and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 423 may further be transmitted or received over a communications network 426 using a transmission medium via the network interface device 420 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### Examples

Example No. 1 is a process including receiving a request from a user to add a block to a digital ledger; determining from the request a first address at which the block is proposed to be added to the digital ledger; searching for a second address that closely matches the first address; determining if the second address closely matches the first address; and when the second address closely matches the first address, transmitting a message to the user indicating that there is a possible error in the first address.

Example No. 2 includes all the features of Example No. 1, and optionally includes determining that the first address is a not a registered address in the digital ledger; and searching for the second address that closely matches the first address when the first address is not a registered address.

Example No. 3 includes all the features of Example Nos. 1-2, and optionally includes a process wherein the search for the second address and the determination that the second address closely matches the first address is executed using a regular expression algorithm.

Example No. 4 includes all the features of Example Nos. 1-3, and optionally includes a process wherein the second address closely matches the first address when a difference between numbers and characters in the first address and in the second address exceeds a threshold.

Example No. 5 includes all the features of Example Nos. 1-4, and optionally includes a process wherein the threshold comprises half or more of the numbers and the characters don't match in a same position in the first address and the second address.

Example No. 6 includes all the features of Example Nos. 1-5, and optionally includes a process including suggesting to the user that the second address is an intended address of the user.

Example No. 7 includes all the features of Example Nos. 1-6, and optionally includes a process wherein the digital ledger comprises a cryptocurrency system.

Example No. 8 includes all the features of Example Nos. 1-7, and optionally includes a process wherein the digital ledger comprises a blockchain system.

Example No. 9 is a process including receiving a request from a user to add a block to a digital ledger; determining from the request an address at which the block is proposed to be added to the digital ledger; determining if the address is registered and has been used; and when the address is registered but has not been used, denying the request from the user to add the block to the digital ledger, or requesting a confirmation from the user that the user wants to add the block to the digital ledger at the address.

Example No. 10 includes all the features of Example No. 9, and optionally includes a process wherein the determination that the address has been used comprises determining that the address has been used in a transaction in the digital ledger or that the address has been used in a signed message in the digital ledger.

Example No. 11 includes all the features of Example Nos. 9-10, and optionally includes a process wherein the confirmation from the user includes permitting the user to transmit a trial transaction to the address; verifying that the trial transaction has reached the address; and permitting the user to transmit a commit transaction to the address.

Example No. 12 includes all the features of Example Nos. 9-11, and optionally includes a process wherein the digital ledger comprises a cryptocurrency system.

Example No. 13 includes all the features of Example Nos. 9-12, and optionally includes a process wherein the digital ledger comprises a blockchain system.

Example No. 14 is a process including receiving a request from a user to add a block to a digital ledger; refraining from adding the block to the digital ledger for a predetermined threshold time period; and after an expiration of the predetermined threshold time period, adding the block to the digital ledger.

Example No. 15 includes all the features of Example No. 14, and optionally includes a process including receiving a request, prior to the expiration of the predetermined threshold time period, to cancel the request to add the block to the digital ledger; and canceling the request to add the block to the digital ledger.

Example No. 16 includes all the features of Example Nos. 14-15, and optionally includes a process wherein the predetermined threshold time period is created by the user or the predetermined threshold time period is created by a system operator.

Example No. 17 includes all the features of Example Nos. 14-16, and optionally includes a process wherein the refraining from adding the block to the digital ledger for the predetermined threshold time period is executed in the digital ledger, a hardware wallet, a software wallet, or an exchange.

Example No. 18 includes all the features of Example Nos. 14-17, and optionally includes a process wherein the refraining comprises holding the request in an escrow memory.

Example No. 19 includes all the features of Example Nos. 14-18, and optionally includes a process wherein the digital ledger comprises a cryptocurrency system.

Example No. 20 includes all the features of Example No. 14-19, and optionally includes a process wherein the digital ledger comprises a blockchain system.

1. A process comprising:
receiving a request from a user to add a block to a digital ledger;
determining from the request a first address at which the block is proposed to be added to the digital ledger;
searching for a second address that closely matches the first address;
determining if the second address closely matches the first address; and
when the second address closely matches the first address, transmitting a message to the user indicating that there is a possible error in the first address.

2. The process of claim 1, comprising:
determining that the first address is a not a registered address in the digital ledger; and
searching for the second address that closely matches the first address when the first address is not a registered address.

3. The process of claim 1, wherein the search for the second address and the determination that the second address closely matches the first address is executed using a regular expression algorithm.

4. The process of claim 1, wherein the second address closely matches the first address when a difference between numbers and characters in the first address and in the second address exceeds a threshold.

5. The process of claim 4, wherein the threshold comprises half or more of the numbers and the characters don't match in a same position in the first address and the second address.

6. The process of claim 1, comprising suggesting to the user that the second address is an intended address of the user.

7. The process of claim 1, wherein the digital ledger comprises a cryptocurrency system.

8. The process of claim 1, wherein the digital ledger comprises a blockchain system.

9. A process comprising:
receiving a request from a user to add a block to a digital ledger;
determining from the request an address at which the block is proposed to be added to the digital ledger;
determining if the address is registered and has been used; and
when the address is registered but has not been used, denying the request from the user to add the block to the digital ledger, or requesting a confirmation from the user that the user wants to add the block to the digital ledger at the address.

10. The process of claim 9, wherein the determination that the address has been used comprises determining that the address has been used in a transaction in the digital ledger or that the address has been used in a signed message in the digital ledger.

11. The process of claim 9, wherein the confirmation from the user comprises:
permitting the user to transmit a trial transaction to the address;
verifying that the trial transaction has reached the address; and
permitting the user to transmit a commit transaction to the address.

12. The process of claim 9, wherein the digital ledger comprises a cryptocurrency system.

13. The process of claim 9, wherein the digital ledger comprises a blockchain system.

14. A process comprising:
receiving a request from a user to add a block to a digital ledger;
refraining from adding the block to the digital ledger for a predetermined threshold time period; and
after an expiration of the predetermined threshold time period, adding the block to the digital ledger.

15. The process of claim 14, comprising:
receiving a request, prior to the expiration of the predetermined threshold time period, to cancel the request to add the block to the digital ledger; and
canceling the request to add the block to the digital ledger.

16. The process of claim 14, wherein the predetermined threshold time period is created by the user or the predetermined threshold time period is created by a system operator.

17. The process of claim 14, wherein the refraining from adding the block to the digital ledger for the predetermined threshold time period is executed in the digital ledger, a hardware wallet, a software wallet, or an exchange.

18. The process of claim 14, wherein the refraining comprises holding the request in an escrow memory.

19. The process of claim 14, wherein the digital ledger comprises a cryptocurrency system.

20. The process of claim 14, wherein the digital ledger comprises a blockchain system.
